(19) United States
(12) Patent Application Publication
(10) Pub. No.: US 2008/0090569 A1
(43) Pub. Date: Apr. 17, 2008

(54) METHOD AND APPARATUS FOR PERFORMING SIGNAL PROCESSING IN AN IP MULTIMEDIA SUBSYSTEM NETWORK

(75) Inventors: ARSHAD KHAN, AUSTIN, TX (US); BERNARD KU, AUSTIN, TX (US); NIRAL SHETH, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/549,351

(22) Filed: Oct. 13, 2006

(51) Int. Cl. H04Q 7/20

(52) U.S. Cl. 455/435.1

(57) ABSTRACT

A method and apparatus for performing signal processing in an IMS network is disclosed. An apparatus that incorporates teachings of the present disclosure may include, for example, an S-CSCF having a controller element that receives an incoming call initiated by a first terminal device directed to a second terminal device, identifies in a registration table a P-CSCF in response to detecting a match between the incoming call and an entry in the registration table, and forwards the incoming call to the P-CSCF to alert the second terminal device of said incoming call. Additional embodiments are disclosed.

### FIELD OF THE DISCLOSURE

The present disclosure relates generally to signaling techniques in a communication system and more specifically to a method and apparatus for performing signal processing in an IP Multimedia Subsystem (IMS) network.

### BACKGROUND

IMS is a standardized Next Generation Network (NGN) architecture that converges mobile and fixed multimedia services. IMS can support Voice over IP (VoIP) based on a 3GPP (3^{rd} Generation Partnership Project) standardized implementation of Session Initiation Protocol (SIP), and can operate over a standard Internet protocol (IP) network. Existing phone systems utilizing packet-switched or circuit-switched techniques can be supported by IMS.

Although IMS advances the convergence of the aforementioned communication technologies, the signaling portion of the IMS standard can be inefficient when establishing communications between terminal devices served by the same Serving Call Session Control Function (S-CSCF).

A need therefore arises for a method and apparatus for performing signal processing in an IMS network.

### BRIEF DESCRIPTION OF THE DRAWINGS

FIG. 1 depicts an exemplary embodiment of a terminal device;

FIG. 2 depicts an exemplary method operating in portions of an IP Multimedia Subsystem (IMS) network;

FIG. 3 depicts an exemplary embodiment an IMS network from which a plurality of terminal devices operate; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for performing signal processing in an IMS network.

In a first embodiment of the present disclosure, a computer-readable storage medium in a Serving Call Session Control Function (S-CSCF) can have computer instructions for receiving a Uniform Resource Identifier (URI) corresponding to an incoming call initiated by a first terminal device directed to a second terminal, identifying in a registration table of the S-CSCF a Proxy Call Session Control Function (P-CSCF) in response to detecting a match between the URI and an entry in the registration table, and forwarding the URI to the P-CSCF to alert the second terminal device of the incoming call.

In a second embodiment of the present disclosure, an S-CSCF can have a controller element that receives an incoming call initiated by a first terminal device directed to a second terminal device, identifies in a registration table a P-CSCF in response to detecting a match between the incoming call and an entry in the registration table, and forwards the incoming call to the P-CSCF to alert the second terminal device of said incoming call.

In a third embodiment of the present disclosure, a computer-readable storage medium in a first terminal device operating in an IP Multimedia Subsystem (IMS) network can have computer instructions for initiating a call to a second terminal device which is directed to and processed by an S-CSCF that identifies in its registration table a P-CSCF in response to detecting a match between the call and an entry in the registration table, and forwards the call to the P-CSCF to alert the second terminal device of said call.

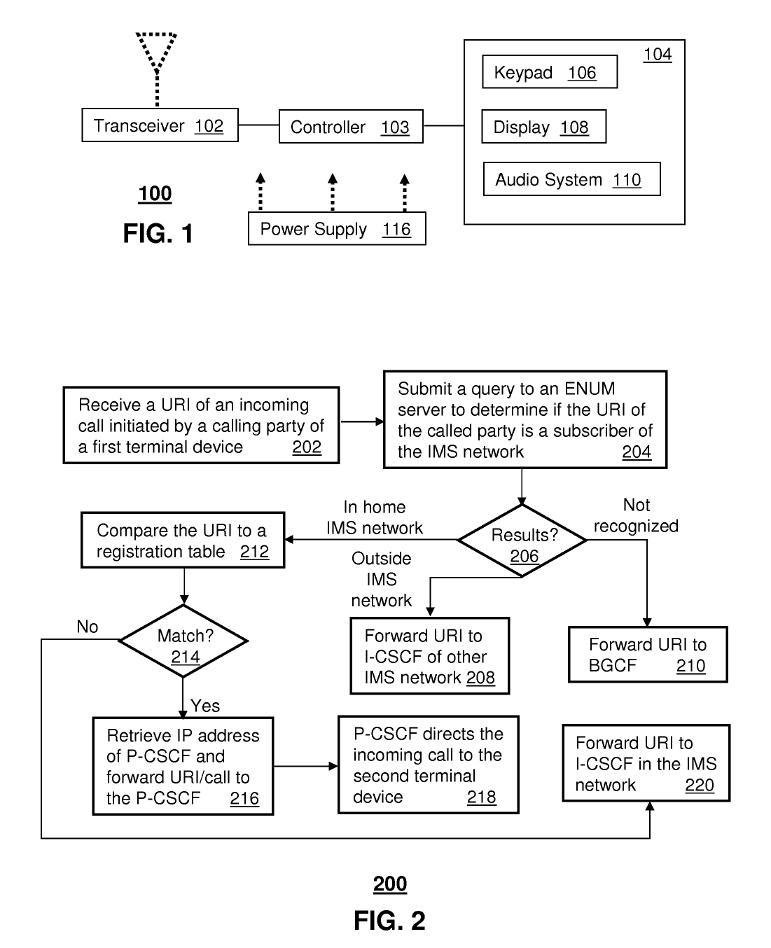

FIG. 1 depicts an exemplary embodiment of a terminal device 100. The terminal device 100 can comprise a wireless or wireline transceiver 102, a user interface (UI) 104, a power supply 116, and a controller 103 for managing operations of the foregoing components. The transceiver 102 can utilize common communication technologies to support singly or in combination any number of wireline access technologies such as cable, xDSL, Public Switched Telephone Network (PSTN), and so on.

Singly or in combination with the wireline technology, the transceiver 102 can support singly or in combination any number of wireless access technologies including without limitation Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the terminal device 100. It should be noted also that next generation wireline and wireless access technologies can also be applied to the present disclosure.

The UI element 104 can include a keypad 106 with depressible or touch sensitive keys and a navigation element such as a navigation disk, button, roller ball, or flywheel for manipulating operations of the terminal device 100. The UI element 104 can further include a display 108 such as monochrome or color LCD (Liquid Crystal Display) which can be touch sensitive for manipulating operations of the terminal device 100 and for conveying images to the end user of said device, and an audio system 110 that utilizes common audio technology for conveying and intercepting audible signals of the end user.

The power supply 116 can utilize common power management technologies such as replaceable batteries, supply regulation technologies, and charging system technologies for supplying energy to the components of the terminal device 100 and to facilitate portable applications. Depending on the type of power supply 116 used, the terminal device 100 can represent an immobile or portable communication device. The controller 103 can utilize computing technologies such as a microprocessor and/or digital signal processor (DSP) with associated storage memory such a Flash, ROM, RAM, SRAM, DRAM or other like technologies for controlling operations of the terminal device 100.

The terminal device 100 can further represent a single operational device or a family of devices configured in a master-slave arrangement. In the latter embodiment, the components of the terminal device 100 can be reused in different form factors for the master and slave terminal devices.

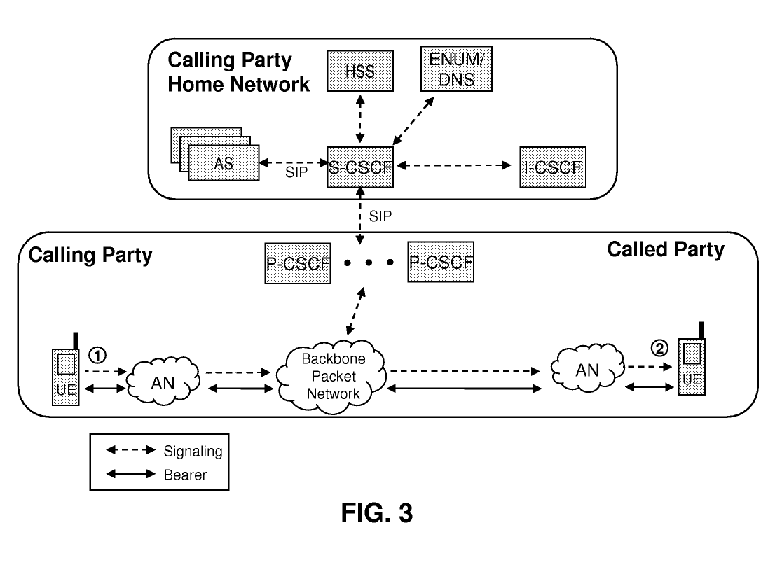

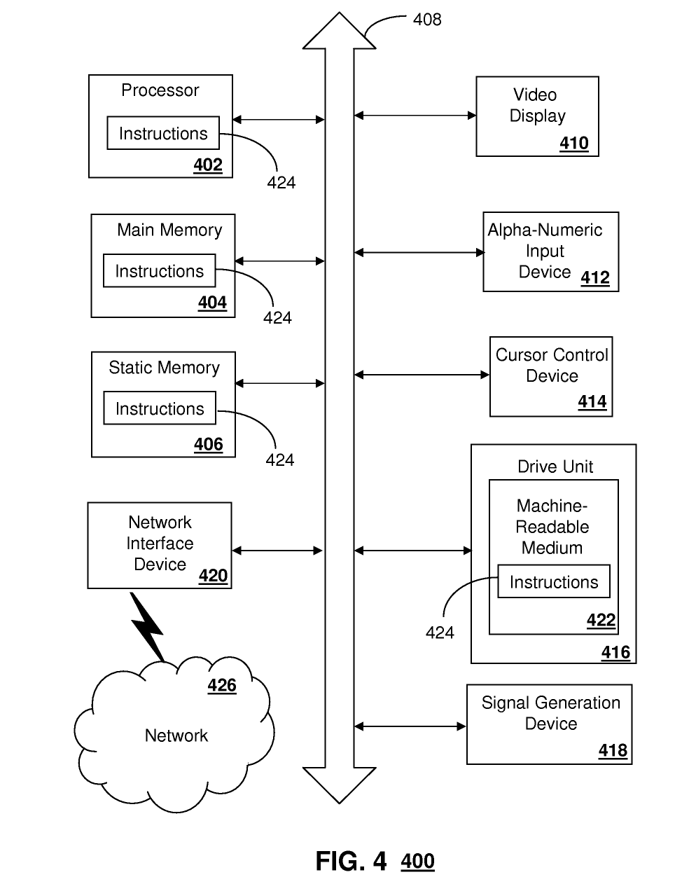

FIG. 2 depicts an exemplary embodiment of a method 200 operating in portions of an IMS network such as shown in FIG. 3. The IMS network can comprise among other things a Proxy Call Session Control Function (P-CSCF), an Interrogating CSCF (I-CSCF), a Serving CSCF (S-CSCF), a Home Subscriber Server (HSS), an tElephone NUmber Mapping (ENUM) and Domain Name Service (DNS) server, an Application Server (AS), an Access Network (AN), a backbone packet-switched network, and two IMS terminals denoted by the numbers 1 and 2. Signaling and bearer activities are depicted by dashed versus solid lines between IMS terminal devices.

A P-CSCF can be a Session Initiation Protocol (SIP) proxy serving as a first point of contact to IMS terminals. An I-CSCF is a SIP proxy that can among other things query the HSS to retrieve IMS terminal location and route SIP calls to its assigned S-CSCF. An S-CSCF is a SIP server that can handle SIP registrations, which allows it to bind the IMS terminal device to a location. It can also decide which ASs to forward a SIP message to in order to provide the services offered by the ASs. ASs can also provide routing services using ENUM lookups, and can enforce the policy of a service provider of the IMS network. The ASs host and execute value-added IMS services (e.g., Caller ID, Call waiting, Push To Talk, etc.).

The HSS can serve as a master database that supports the IMS network for handling calls. It can contain subscription information. It can also perform authentication and authorization of an IMS terminal, and can provide information about the physical location of an IMS terminal. The ENUM/DNS server is a domain name service or DNS-based protocol that is best suited to offer services that expand a means to complete calls over IP networks. It provides a user with a domain name on an E.164 server in order to associate a common international telephone number with a uniform resource identifier or URI and provides other DNS-related services. The DNS function can be used to look up Internet addresses for services such as SIP VoIP telephony.

The ANs support wireline or wireless access technologies such as those described earlier for the terminal device 100. IMS terminals can represent residential or commercial fixed line IMS terminals as well as portable IMS terminals such as cellular phones conforming to an IMS standard. The packet-switched backbone can represent a packet network supporting any number of protocols such as IP, Multi-Protocol Label Switching (MPLS), Asynchronous Transfer Mode/Frame Relay (ATM/FR), and so on.

When an IMS terminal roams in and out of its home IMS network, or by way of periodic registration refresh cycles, it registers with the IMS network and can be reassigned to the same S-CSCF it was assigned to before or a new S-CSCF. During the registration process, the S-CSCF can maintain a cache database in a registration table comprising information relating to IMS terminals it is serving. The registration table can be used to improve call processing efficiency as will be discussed shortly. The registration process in an IMS network is well known in the art. Accordingly, it will not be described in detail in the present disclosure.

With this in mind, method 200 illustrates a call processing technique between IMS terminals 1 and 2 of FIG. 3. Method 200 begins with step 202 in which a P-CSCF receives a URI corresponding to an incoming call initiated by a calling party in possession of the first IMS terminal depicted in FIG. 3. The URI can represent a TELephone URI (TEL URI) or a SIP URI. Upon receiving the URI call, the P-CSCF forwards the URI to its S-CSCF, which is the S-CSCF assigned to the first IMS terminal device (herein referred to as the calling party's S-CSCF). The calling party's S-CSCF in step 204 submits an ENUM query to the ENUM/DNS server to determine in step 206 if the URI of the called party is within its home IMS network, an outside IMS network, or not recognized.

If the URI belongs to a subscriber of the IMS network from which the first IMS terminal operates, then the calling party's S-CSCF proceeds to step 212 where it compares the URI to its registration table to determine if the second IMS terminal device is served by the calling party's S-CSCF or another S-CSCF. If the second IMS terminal device is served by the calling party's S-CSCF, the calling party's S-CSCF proceeds to step 216 where it retrieves an IP address for a P-CSCF from the registration table and forwards the URI invite to said P-CSCF. The IP address can be of the same P-CSCF that received the incoming call if it assigned to the second IMS terminal device or another P-CSCF assigned thereto. The P-CSCF receiving the URI in turn directs the incoming call to the second IMS terminal utilizing well known techniques in the art for establishing an IMS communication session between the first and second IMS terminal devices.

Referring back to step 214, if there is no match between the URI and entries in the registration table, the calling party's S-CSCF proceeds to step 220 where it forwards the URI to an I-CSCF identified by the ENUM/DNS server. The I-CSCF serves to find an S-CSCF assigned to the second IMS terminal device (herein referred to as the called party's S-CSCF) by submitting queries to the HSS. Once identified, the I-CSCF can forward the URI invite to the called party's S-CSCF for further processing. The called party's S-CSCF can in turn apply service logic according to one or more ASs, retrieve an IP address of a P-CSCF in the called party's area, and forward the incoming call to said P-CSCF to alert the second IMS terminal device as previously described.

Referring back to step 206, if the ENUM query identifies the URI as belonging to a subscriber assigned to an outside IMS network, the called party's S-CSCF proceeds to step 208. This step represents a use case in which the ENUM/DNS server contains information shared among multiple IMS networks. The shared information can be the result of brokering deals between IMS service providers. In step 208, the called party's S-CSCF identifies an I-CSCF of the outside IMS network from the ENUM query. The called party's S-CSCF retrieves an IP address for the I-CSCF from the DNS portion of the ENUM/DNS server. Once the IP address is identified, the called party's S-CSCF forwards the URI to the I-CSCF of the outside IMS network. The I-CSCF in response finds the called party's S-CSCF from the HSS of the outside IMS network and directs the URI to the called party's S-CSCF to establish an IMS communication session between the first and second IMS terminal devices as previously described.

In step 206, if the ENUM query indicates that the URI cannot be identified, the called party's S-CSCF proceeds to step 210 where it forwards the URI to a Breakout Gateway Control Function (BGCF). The BGCF can interact with a Media Gateway Control Function (MGCF) and a Signaling Gateway Control Function (SGCF) to establish communications in cases where the second terminal device corresponds to a PSTN terminal.

Method 200 provides a means that substantially improves call processing in an IMS network. In particular, when first and second IMS terminal devices are assigned to the same S-CSCF, the S-CSCF can be programmed to process the URI invite of the first IMS terminal device without forwarding said URI invite to an I-CSCF to determine which S-CSCF the second IMS terminal device has been assigned to. Eliminating this step avoids an unnecessary number of call processing steps utilized by prior art systems which inevitably result in a loopback of the URI invite back to the same S-CSCF. Instead method 200 discloses a process in which each S-CSCF can be programmed to check in its registration table whether the called IMS terminal device is served by the same S-CSCF as the calling IMS terminal device. If it is, then call processing is handled by the same S-CSCF for the calling and called IMS terminal devices. Otherwise, it is handled as in prior art systems.

Upon reviewing the aforementioned embodiments, it would be evident to an artisan with ordinary skill in the art that said embodiments can be modified, reduced, or enhanced without departing from the scope and spirit of the claims described below. Accordingly, the reader is directed to the claims section for a fuller understanding of the breadth and scope of the present disclosure.

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a Serving Call Session Control Function (S-CSCF), comprising computer instructions for:
receiving a Uniform Resource Identifier (URI) corresponding to an incoming call initiated by a first terminal device directed to a second terminal;
identifying in a registration table of the S-CSCF a Proxy Call Session Control Function (P-CSCF) in response to detecting a match between the URI and an entry in the registration table; and
forwarding the URI to the P-CSCF to alert the second terminal device of the incoming call.

2. The storage medium of claim 1, wherein the URI comprises one among a TELephone URI (TEL URI) and a Session Initiation Protocol (SIP) URI, and wherein the storage medium comprises computer instructions for identifying an IP address of the P-CSCF in the registration table to forward the URI to said P-CSCF.

3. The storage medium of claim 1, wherein the URI conforms to a tElephone NUmber Mapping (ENUM) standard.

4. The storage medium of claim 1, comprising computer instructions for performing the identification step in response to determining from an ENUM query that the URI belongs to a subscriber of an IP Multimedia Subsystem (IMS) network from which the S-CSCF operates.

5. The storage medium of claim 1, comprising computer instructions for forwarding the URI to an Interrogating CSCF (I-CSCF) identified in an ENUM query in response to determining from said ENUM query that the URI belongs to a subscriber of an IMS network from which the S-CSCF does not operate.

6. The storage medium of claim 5, comprising computer instructions for determining an IP address of the I-CSCF from a Domain Name Service (DNS) prior to forwarding the URI to the I-CSCF.

7. The storage medium of claim 1, comprising computer instructions for forwarding the URI to a Breakout Gateway Control Function in response to determining from an ENUM query that the URI is not recognized.

8. The storage medium of claim 1, comprising computer instructions for:
detecting no match between the URI and entries in the registration table; and
forwarding the URI to an I-CSCF identified from an ENUM query.

9. The storage medium of claim 1, wherein the registration table comprises a cache operated by the S-CSCF, and wherein the storage medium comprises computer instructions for populating entries in the registration table according to a registration process conforming to an IMS standard.

10. The storage medium of claim 1, wherein the first and second terminal devices correspond to one among wireline and wireless VoIP terminals.

11. A Serving Call Session Control Function (S-CSCF), comprising a controller element that receives an incoming call initiated by a first terminal device directed to a second terminal device, identifies in a registration table a Proxy Call Session Control Function (P-CSCF) in response to detecting a match between the incoming call and an entry in the registration table, and forwards the incoming call to the P-CSCF to alert the second terminal device of said incoming call.

12. The S-CSCF of claim 11, wherein the incoming call comprises a URI, wherein the URI comprises one among a TELephone URI (TEL URI) and a Session Initiation Protocol (SIP) URI, and wherein the URI conforms to a tElephone NUmber Mapping (ENUM) standard.

13. The S-CSCF of claim 11, wherein the controller element performs the identification step in response to determining from an ENUM query that a called party targeted by the incoming call is a subscriber of an IP Multimedia Subsystem (IMS) network from which the S-CSCF operates.

14. The S-CSCF of claim 11, wherein the controller element determines from a Domain Name Service (DNS) an IP address of an Interrogating CSCF (I-CSCF) identified in an ENUM query, and forwards the incoming call to said I-CSCF in response to determining from said ENUM query that the called party is a subscriber of an IMS network from which the S-CSCF does not operate.

15. The S-CSCF of claim 11, wherein the controller element forwards the incoming call to a Breakout Gateway Control Function in response to determining from an ENUM query that the incoming call is not recognized.

16. The S-CSCF of claim 11, wherein the controller element detects no match between the incoming call and entries in the registration table, and forwards the incoming call to an I-CSCF identified from an ENUM query.

17. A computer-readable storage medium in a first terminal device operating in an IP Multimedia Subsystem (IMS) network, comprising computer instructions for initiating a call to a second terminal device which is directed to and processed by a Serving Call Session Control Function (S-CSCF) that identifies in its registration table a Proxy Call Session Control Function (P-CSCF) in response to detecting a match between the call and an entry in the registration table, and forwards the call to the P-CSCF to alert the second terminal device of said call.

18. The storage medium of claim 17, wherein the S-CSCF performs the identification step in response to determining from an ENUM query that a called party targeted by the call is a subscriber of an IP Multimedia Subsystem (IMS) network from which the S-CSCF operates.

19. The storage medium of claim 17, wherein the S-CSCF forwards the call to a Breakout Gateway Control Function in response to determining from an ENUM query that the call is not recognized.

20. The storage medium of claim 17, wherein the S-CSCF detects no match between the call and entries in the registration table, and forwards the call to an I-CSCF identified from an ENUM query.
